(19) United States
(12) Patent Application Publication
(10) Pub. No.: US 2010/0033392 A1
(43) Pub. Date: Feb. 11, 2010

(54) TAPERED MEANDER LINE ANTENNA

(75) Inventor: Vadim V. Piskun, San Jose, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/479,022

(22) Filed: Jun. 5, 2009

Related U.S. Application Data
(60) Provisional application No. 61/086,621, filed on Aug. 6, 2008.

(51) Int. Cl. H01Q 11/10; H01P 11/00; H01Q 1/38

(52) U.S. Cl. 343/792.5; 29/601; 343/700 MS

(57) ABSTRACT

A tapered meander line antenna is formed by having a conductive material disposed on or in a non-conductive material, in which a length of the conductive material traversing from a proximal end to a distal end meanders in an approximately perpendicular direction from an axis of traversal from the proximal end to the distal end. The spacing between conductive lines that meander are made non-uniform and tapered to have less spacing between the conductors toward the distal end. In one instance the spacing is tapered to have a logarithmic pattern.

### CROSS REFERENCE TO RELATED APPLICATION

This application claims the benefit of priority to U.S. Provisional Patent Application having an application No. 61/086,621, filed Aug. 6, 2008, and titled “Tapered Meander Line Antenna” which is incorporated herein by reference in its entirety.

### BACKGROUND OF THE INVENTION

1. Technical Field of the Invention

The embodiments of the invention relate to antennas and more particularly to a construction of meander line antennas.

2. Description of Related Art

Communication systems are known to support wireless and wire lined communications between wireless and/or wire lined communication devices. Such communication systems range from national and/or international cellular telephone systems, the Internet and to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

For wireless communications, a wireless communication device, such as a cellular telephone, two-way radio, personal digital assistant (PDA), personal computer (PC), laptop or notebook computer, home entertainment equipment, as well as other devices, communicates wirelessly with another device, a router, base station, etc. For each device to participate in wireless communications, it typically includes a built-in radio transceiver (i.e., receiver and transmitter) or is coupled to an associated radio transceiver. In order to receive and/or transmit signals, a wireless device typically includes an antenna. In some instances, multiple antennas are utilized.

Although early wireless devices operated adequately with the use of external antennas, the present trend is to incorporate the antenna internally to the device. Typical practice is to incorporate the antenna as part of the circuit board that contains the radio frequency (RF) integrated circuit, incorporate the antenna as part of the device itself or construct the antenna as part of the integrated circuit. Whether the antenna is placed on a device, circuit board, substrate or within a chip, the practice of integrating an antenna within a wireless device generally requires the antenna to be much smaller in size with today's devices. One antenna construction technique uses meander line conductors to form the antenna. FIG. 1 shows one example prior art meander line antenna 10. Antenna 10 is formed on a board or a substrate base 13, in which a ground pad 11 and a conductor 12 also take a planar form (x and y direction) and are formed on or within base 13. The conductor is a line conductor having a proximal end 14 and a distal end 15, wherein the proximal end 14 is adjacent to ground, but typically not directly coupled to ground 11.

As shown in FIG. 1, conductor 12 that forms the antenna is arranged as a meander line, in which the meander has a uniformly spaced rectangular shape between the two ends 14, 15. That is, conductor 12 extends from its proximal end 14 to distal end 15 in the y-axis direction, but meanders back-and-forth along the x-axis direction, and this meander is rectangular in shape. Meander is the term used to describe the back-and-forth pattern of the conductor. As noted, the gap distance between the lines in the meander is uniform (even) with prior art antenna 10.

Although a line meander antenna may place a long conductor over a small space, one noted disadvantage results from the cancellation current that develops along the conductor path and may also increase the reflected power. Since the current flow reverses direction whenever the meander changes direction along the x-axis, an induced field change is also experienced with the reversal of the current flow direction. In some instances, the reverse field may impart a cancellation effect to the overall current and/or induce heightened reflected power, resulting in radiated power loss from antenna 10.

Accordingly, there is a need for meander line antennas to attempt to reduce this power loss.

### SUMMARY OF THE INVENTION

The present invention is directed to apparatus and methods of operation that are further described in the following Brief Description of the Drawings, the Detailed Description of the Invention, and the Claims. Other features and advantages of the present invention will become apparent from the following detailed description of the embodiments of the invention made with reference to the accompanying drawings.

### BRIEF DESCRIPTION OF THE SEVERAL VIEWS OF THE DRAWINGS

FIG. 1 shows a prior art meander line antenna with uniform conductor spacing in the meander.

FIG. 2 shows one embodiment of a meander line antenna of the present invention in which a tapered conductor spacing is used in the meander.

FIG. 3 shows another embodiment of a meander line antenna of the present invention in which a tapered conductor spacing is used with a wavy meander.

FIG. 4 is a top plan view showing one embodiment of a meander line antenna of the present invention in which a tapered conductor spacing that follows a logarithmic pattern is used in the meander.

FIG. 5 shows a pictorial diagram of an antenna propagation pattern from the tapered meander line antenna of FIG. 4 that has a logarithmic pattern.

FIG. 6 is a graphic illustration comparing a prior art meander antenna of FIG. 1 to the tapered meander line antenna of FIG. 4 when comparing reflected power response over a selected frequency range.

### DETAILED DESCRIPTION OF THE INVENTION

The embodiments of the present invention may be practiced in a variety of settings that implement a meander line antenna.

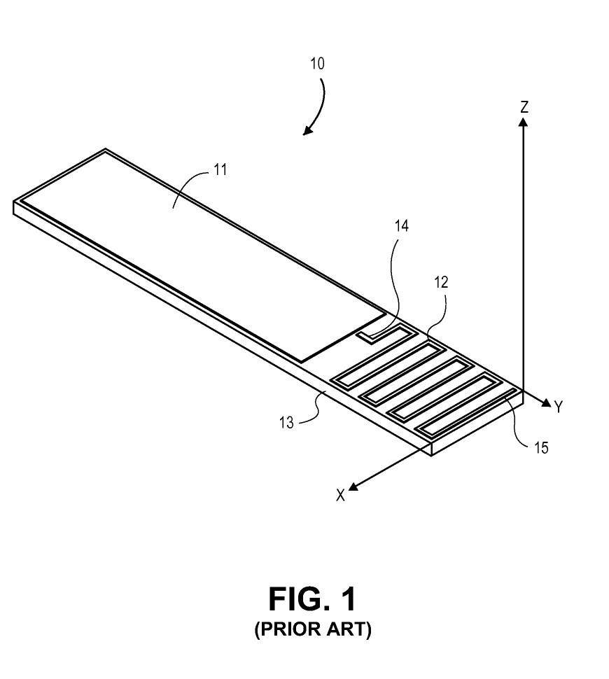

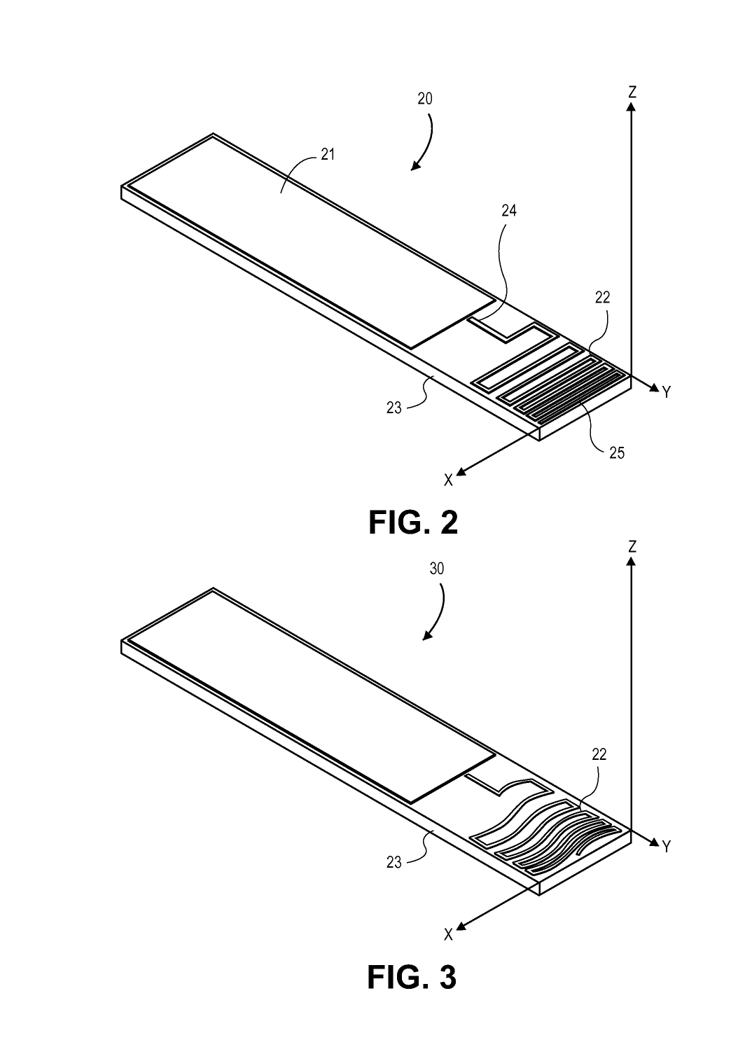

FIG. 2 illustrates one example embodiment of a tapered meander line antenna of the present invention. Tapered meander line antenna 20 has conductor 22 that reside on or in a base 23. Base 23 may be formed similar to base 13 of the prior art antenna of FIG. 1, or may be built on other materials. In one embodiment, base 23 is a substrate that is formed from a dielectric material, such as glass, ceramic, oxide, nitride, etc. A variety of dielectric materials may be used. Base 23 may stand alone or it may be part of a circuit board or built into or as part of a device. When antenna 20 is built as an integrated circuit or part of an integrated circuit, base 23 may be formed from materials that are used as dielectric or passivating materials in integrated circuits, including oxides and nitrides.

A ground pad 21 and conductor 22 are formed on or in base 23 and may be constructed similar to antenna 10 of FIG. 1. A variety of conducting materials may be used for conductor 22, including but not limited to copper, aluminum, silver, gold and their alloys. Other conductive materials may be used as well. The conductor has a proximal end 24 closer to ground pad 21 and a distal end 25. The proximal end 24 is generally not directly coupled to ground 11. In a typical operation, a transmission line, such as a coax or twin lead, is coupled to antenna 20 for reception or transmission of a signal. For example, with a coax, the center conductor is coupled to proximal end 24 and the shield ground is coupled to ground pad 21. In some applications ground 21 may be an antenna ground that is different from device ground, in which there may be decoupling between the two grounds.

In one embodiment, conductor 22 is formed substantially planar and resides substantially in a two-dimensional (x-y) direction within a x-y-z coordinate representation noted in FIG. 2. There may be a z-component, but generally, conductor 22 is planar in shape. In one embodiment, conductor 22 resides on a substantially planar surface of base 23. In another embodiment, conductor 22 may reside in the material forming base 23. In some instances, conductor 22 may reside on a planar surface of base 23 and a dielectric or passivating material may overlie and cover conductor 22. Conductor 22 that forms the antenna is arranged as a meander line and extends from its proximal end 24 to distal end 25 in the y-axis direction, but meanders back-and-forth along the x-axis direction. In the shown example of FIG. 2, this meander is rectangular in shape. Again, meander is the term used to describe the back-and-forth pattern of the conductor, wherein the meander is typically perpendicular or approximately perpendicular (x-axis) to the axis of traversal (y-axis) of the conductor from proximal end 24 to distal end 25.

Unlike the structure of antenna 10, antenna 20 has a tapered meander pattern. Although it still has the rectangular-shaped meander, the gap separations between the conductor lines are tapered (non-uniform), so that the gaps are larger at proximal end 24 and gap distance between the conductor shrinks in size when moving toward distal end 25 along the y-axis direction. Thus, the taper introduces a non-uniform gap spacing, in which the gap separation becomes smaller when traversing from proximal end 24 to distal end 25.

Generally, the tapered meander line antenna 20 has smaller gap separation between the conductive lines at distal end 25 than at proximal end 24. In a transmission mode where current is input at or near proximal end 24, current amplitude at distal end 25 is significantly less than at proximal end 24. Accordingly, if the gap distance is increased at proximal end 24 where current values are high, the cancellation effects due to the proximity of the conductors are reduced. Similarly, since there is less current at the distal end, the cancellation effects are less, so that the gap separation may be made smaller. Thus, for a substantially same length conductor, the tapered meander line antenna 20 has less cancellation effects than the prior art antenna 10 of FIG. 1, due to the tapered spacing.

The tapered spacing pattern for antenna 20 need not be confined to one particular shape or size and may have various patterns or dimensions. In one embodiment, the taper has a logarithmic relationship, so that the taper of the gap distance from one end to the other is based on a logarithmic scale. The logarithmic relationship allows for ease in mathematically calculating taper dimensions for a particular frequency of use. Instead of a logarithmic pattern, other taper spacing patterns having geometric relationships may be employed. Furthermore, the antenna need not be limited to a logarithmic or geometric taper and other non-uniform gap separations, which may or may not follow a pattern, may be used as well.

FIG. 3 shows another embodiment of a tapered meander line antenna. In this instance antenna 30 is formed similar to antenna 20, but conductor 22 is arranged in a wavy meander. That is, the rectangular arrangement of the conductor of FIG. 2 is set to have a wave. The application of the taper is equivalent to antenna 20 of FIG. 2 and is shown as an example of modifying the straight conductor of antenna 20 to implement a tapered meander antenna. Furthermore, although a rectangular and wavy rectangular conductor shapes are shown, the meander need not be limited to rectangular shapes. Other variations to the rectangular conductor of FIG. 2 or the wavy rectangular conductor of FIG. 3 may be implemented without departing from the spirit and scope of the invention. For example, the corners of the meander may have rounded corners (instead of angular corners) in other embodiments. Furthermore, in other embodiments, the conductor may be a coiled conductor, instead of a planar line conductor. The conductor may also utilize a fractal pattern. In order to practice the various embodiments of the invention, a tapered meander is to be implemented, in which the taper has non-uniform gap separation between the conductive lines.

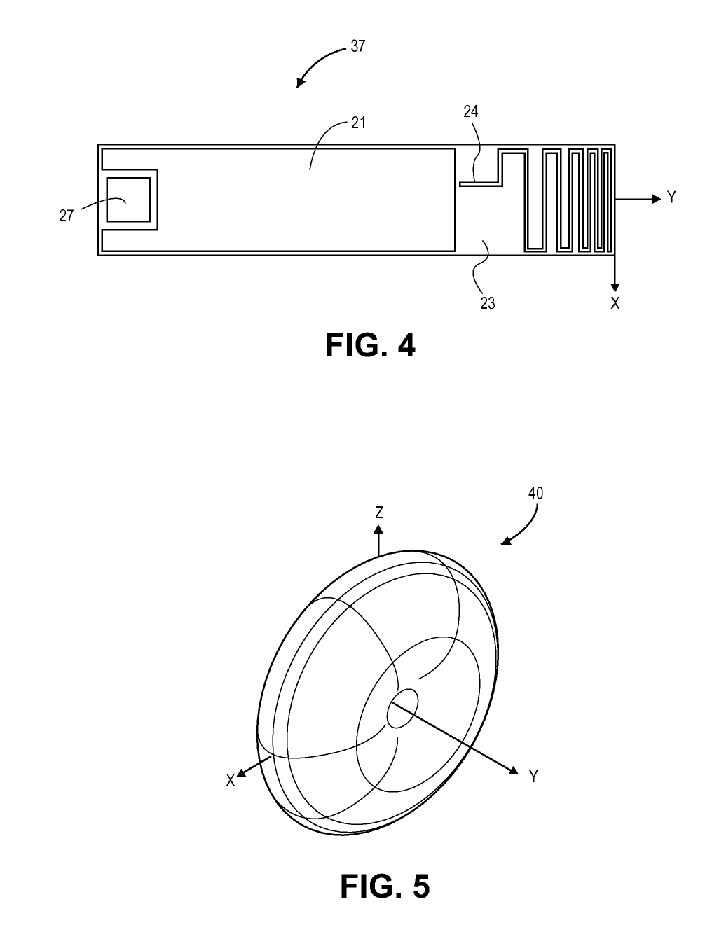

FIG. 4 shows another embodiment of the invention. FIG. 4 shows a top view of a tapered meander line antenna 37, which is equivalent to antenna 20 of FIG. 2, but now shows a separate ground pad 27. In this embodiment, antenna ground is provided by ground pad 21, which is separate from circuit and/or chip ground provided at ground pad 27. A decoupling device or circuit may be used to separate the two grounds and decouple antenna ground at pad 21 from circuit or chip ground at pad 27.

FIG. 5 shows a radiation pattern 40 from a use of a tapered meander line antenna, such as antenna 27 of FIG. 4. The x, y and z directions correlate to the x-, y- and z-axes of antenna 27. Note that the z-axis emanates out of the paper in FIG. 4. When compared to radiation patterns of similar prior art antennas which use a uniform meander, the radiation power is typically more pronounced with the tapered meander line antenna at a given frequency designed for the antenna.

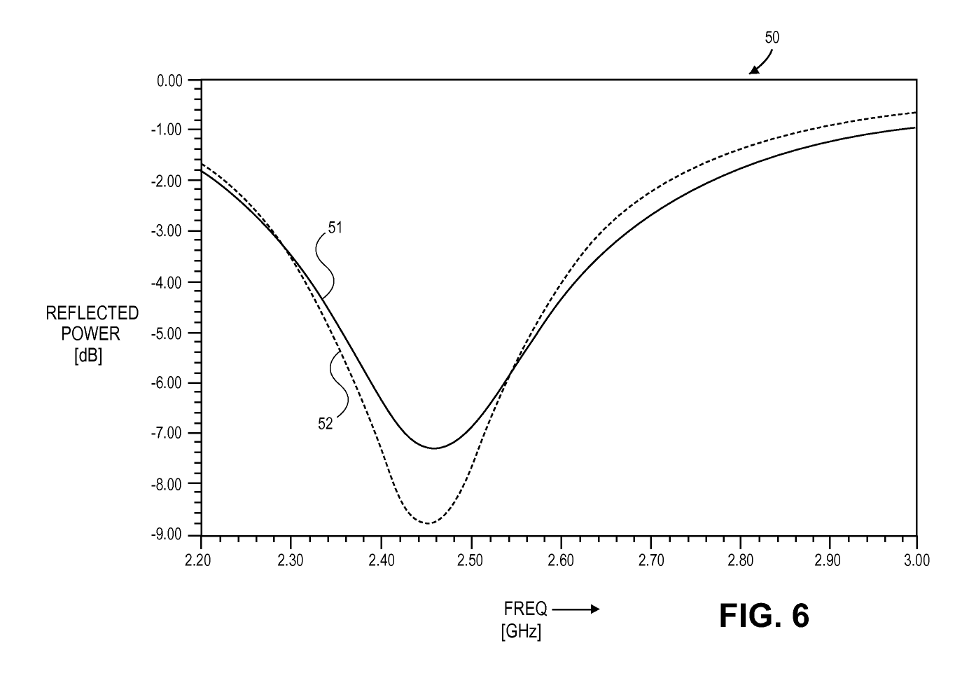

FIG. 6 is a graph 50 showing a measurement of reflected power (in dB) versus frequency (in GHz) for a uniform (or even) meander antenna (such as antenna 10) and for a logarithmic meander antenna (such as antenna 20 or 27). At a given operating frequency range for the antennas, such as approximately between 2.4-2.5 GHz, the logarithmic tapered meander antenna (represented by curve 52) has less reflected power than the uniform meander antenna (represented by curve 51), due to less of the cancellation effect. Accordingly, for a given power input, more power is generated by the tapered meander antenna, since there is less reflection at the designed operating frequency.

Although the improvement in radiated power may be small in some instances, the differences may be significant in certain applications. For example, in applications utilizing Bluetooth technology where very little radiated power is permitted, the use of a tapered meander antenna over uniform meander antenna could result in significant improvement in communications between devices using Bluetooth technology. As another example, a tapered meander antenna, having similar sizing and construction, may replace an even meander antenna in order to improve range or performance of devices using Bluetooth technology.

Many other applications and usages may be implemented within the spirit and scope of the present invention. Likewise, the antenna may be utilized in a variety of devices, including notebook computers, mobile phones, wireless music and/or video players, routers, Bluetooth devices, etc. These are just some examples and the antenna may be implemented in other devices as well.

Thus, a tapered meander line antenna is described.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more of its corresponding functions and may further include inferred coupling to one or more other items.

We claim:

1. An apparatus comprising:
a non-conductive material; and
a conductive material disposed on or in the non-conductive material to form an antenna, in which a length of the conductive material traversing from a proximal end to a distal end meanders in an approximately perpendicular direction from an axis of traversal from the proximal end to the distal end and in which spacing between conductive lines that meander are non-uniform and tapered to have less spacing between the conductors toward the distal end.

2. The apparatus of claim 1, wherein the spacing between the conductive lines is tapered to have a geometric pattern.

3. The apparatus of claim 1, wherein the spacing between the conductive lines is tapered to have a logarithmic pattern.

4. The apparatus of claim 1, wherein the conductive lines have a rectangular meander.

5. The apparatus of claim 4, wherein the spacing between the conductive lines are tapered to have a logarithmic pattern.

6. The apparatus of claim 1, wherein the conductive lines have a rectangular meander with rounded edges.

7. The apparatus of claim 1, wherein the conductive lines have a wavy rectangular meander.

8. The apparatus of claim 7, wherein the spacing between the conductive lines are tapered to have a logarithmic pattern.

9. The apparatus of claim 1, wherein the conductive lines have a wavy rectangular meander with rounded edges.

10. A method comprising:
forming a conductive material on or in a non-conductive material to form an antenna, in which a length of the conductive material traverses from a proximal end to a distal end by meandering in an approximately perpendicular direction from an axis of traversal from the proximal end to the distal end and in which spacing between conductive lines that meander are non-uniform and tapered to have less spacing between the conductors toward the distal end; and
coupling the proximal end to a circuit to couple the antenna to the circuit.

11. The method of claim 10, wherein the spacing between the conductive lines is tapered to have a geometric pattern.

12. The method of claim 10, wherein the spacing between the conductive lines is tapered to have a logarithmic pattern.

13. The method of claim 10, wherein the conductive lines have a rectangular meander.

14. The method of claim 13, wherein the spacing between the conductive lines are tapered to have a logarithmic pattern.

15. The method of claim 10, wherein the conductive lines have a rectangular meander with rounded edges.

16. The method of claim 10, wherein the conductive lines have a wavy rectangular meander.

17. The method of claim 16, wherein the spacing between the conductive lines are tapered to have a logarithmic pattern.

18. The method of claim 10, wherein the conductive lines have a wavy rectangular meander with rounded edges.
